(19) United States
(12) Patent Application Publication
(10) Pub. No.: US 2010/0192349 A1
(43) Pub. Date: Aug. 5, 2010

(54) WINDOW REMOVAL DEVICE

(76) Inventors: Matthew Vishnick, Holtsville, NY (US); Park Benjamin, III, Oyster Bay, NY (US); Jason Vishnick, Holtsville, NY (US); Robert Tucker, Holtsville, NY (US)

Correspondence Address: Pearl Cohen Zedek Latzer, LLP, 1500 Broadway, 12th Floor, New York, NY, 10036, US

(21) Appl. No.: 12/572,654

(22) Filed: Oct. 2, 2009

Related U.S. Application Data
(63) Continuation of application No. 12/381,762, filed on Mar. 16, 2009, now abandoned.
Application No. 12/381,762 is a continuation of application No. 11/884,913, now abandoned.
(60) Provisional application No. 60/656,074, filed on Feb. 24, 2005.

(51) Int. Cl. B23P 19/00

(52) U.S. Cl. 29/426.5; 29/700

(57) ABSTRACT

A device for removal of a window from an existing structure. In a preferred embodiment, the device is provided for removal of a window from a vehicle. Alternatively, the device can be used for removal of another window type, such as the window of a home or an office.

### RELATED APPLICATIONS

The present application is a continuation of U.S. patent application Ser. No. 12/381,762 filed Mar. 16, 2009, which is a continuation of U.S. application Ser. No. 11/884,913 filed Aug. 22, 2007, which is the §371 national phase of PCT Application Serial Number PCT/US06/06456 filed Feb. 24, 2006, which claims the priority of U.S. Provisional Application Ser. No. 60/656,074 filed Feb. 24, 2005, all of which are hereby fully incorporated herein by reference.

### BACKGROUND OF THE INVENTION

In a vehicular accident, it is frequently necessary to remove one or more windows and/or doors from the damaged vehicle as part of rescue efforts to remove the vehicle's driver and passengers. Such removal efforts, however, can themselves result in injury, in the event that shards of glass are sprayed into the vehicle, hitting the vehicle's occupants during rescue. Accordingly, it would be a significant advance in the art to provide a safe means for removal of a window, particularly for use in emergency services, which minimizes the likelihood of injury to vehicular occupants.

### SUMMARY OF THE INVENTION

In accordance with the present invention, a device is provided for removal of a window from an existing structure. In a preferred embodiment, the device is provided for removal of a window from a vehicle. Alternatively, the device can be used for removal of another window type, such as the window of a home or an office.

In a preferred embodiment, the invention is particularly suited for use by emergency and/or law enforcement personnel. In a further preferred embodiment, the invention is provided for removal of the window of a vehicle after an accident, to facilitate extraction of the occupants and rapid application of emergency medical assistance.

### BRIEF DESCRIPTION OF THE DRAWINGS

FIG. 1 is a perspective view of a first embodiment of a window removal device, in accordance with the present invention.

FIG. 2 is a perspective view of a second embodiment of the window removal device disclosed herein.

### DETAILED DESCRIPTION OF THE INVENTION AND THE PREFERRED EMBODIMENTS

In accordance with the present invention, an article of manufacture is provided for removing the window of an automobile. In accordance with the method of the invention, the article is particularly suited for use as a rescue device in vehicular accidents. In such uses, the invention speeds removal of the vehicle's window and access to the vehicle's occupants. At the same time, the design of the device minimizes or eliminates the likelihood of pieces of glass flying into and injuring occupants of the vehicle or rescue workers during window removal and/or during removal of the vehicle's door.

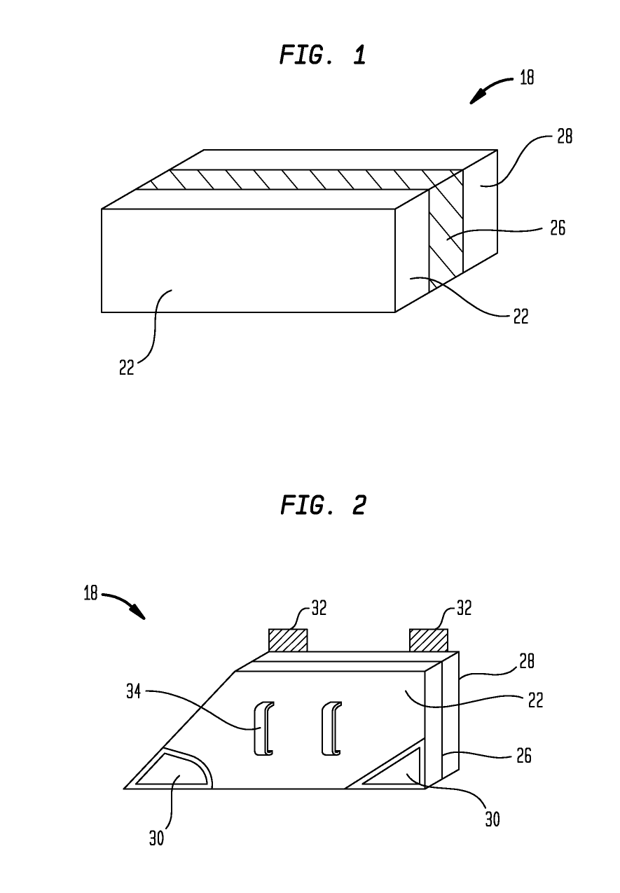

Further to the invention, a window removal device 18 is provided with a first layer of material 22, as illustrated in FIG. 1. Preferably, the first layer of material, or a portion thereof, is transparent, providing the rescue worker(s) with the ability to see the occupant(s) of the vehicle through the material during the rescue operation, and vice versa preferably providing the occupant(s) with the ability to see the rescue worker(s). For example, in one preferred embodiment, the first layer of material 22 is a clear mylar film reinforced with fibers (threads) of fiberglass and/or polyester and/or Kevlar®, such as used in the sailing industry.

In a further additional or alternate embodiment, this layer includes any other suitable fiber providing additional strength to this layer of material, whether nylon fibers and/or carbon fibers, or so forth. Further preferably, one or more intersecting grids of fibers can be provided. For example, a series of horizontal rows of fibers and intersecting vertical rows of fibers forming a graph paper like grid can be used, and/or a series of diagonals (e.g. at a 45 degree angle) can be used forming a grid of diamonds. The rows of horizontal fibers can spaced any desired distance from each other, whether a fixed distance between rows, or a variable distance from row to row, and likewise for any rows of vertical or diagonal fibers.

If desired, the first layer can itself include multiple sublayers. For example, in one preferred construction of a film reinforced with fibers, a device can be created using a mylar film and polyester fiber that are sandwiched together to form the first layer of material. This first layer can be constructed using two rolls of mylar film that are aligned vertically, with a roll of material having polyester fiber film (known as “scrim” and also being on a roll) being placed between them. Each inside layer of the mylar film has an adhesive in order to bond the three rolls together into one product. The product is created by unrolling each roll, and pressing the three layers of material together. As the scrim is pulled forward it is measured across the mylar film material. The first layer of scrim is laid out by the desired number of yarns per inch, which, in one preferred embodiment, amounts to five yarns per inch in each direction, creating a graph-paper-like series of boxes that measure ⅕ or 0.2 of an inch square. In a further preferred embodiment, two layers of fibers are used. In this embodiment, a second layer of scrim is used to apply polyester fibers diagonally, resulting in a diamond-shaped or crisscross pattern of polyester fibers in the material (in addition to the boxes referred to above). The diagonal scrim is also known as “X-ply”. Preferably, the X-ply is laid out ½ or 0.5 of an inch apart or every 6 degrees off the warp yarn (diagonal about 0.5-1 inch apart), with the X-ply being placed directly on top of the polyester fiber scrim boxes. After the X-ply is set in place, along with the other three rolls of materials, the materials (mylar rolls, polyester scrim roll and polyester X-ply roll) are united by the use of pressure and an adhesive, thus creating the material for the device. Further preferably, the final thickness of the first layer is approximately 3 mm. However, it will be understood that the device is not limited to any particular embodiment and that other materials, configurations, and dimensions, for the layers, fibers, adhesives, and so forth can be used consistent with the invention.

As an alternative to a transparent (e.g. mylar) layer, an opaque layer can be utilized. For example, in one alternate embodiment, the entire first layer of material 22 is Kevlar®. In either embodiment, whether using a transparent or opaque layer, it is preferred that the type and thickness of material be chosen to avoid a layer which might have the tendency to roll or curl up, making it more difficult to manipulate the sheet and more difficult to attach the sheet to the window in the method discussed below. It is further preferred that any material used (like the reinforced mylar film) have sufficient strength and resistance to puncture and tearing that glass shards from the vehicle window will not puncture or tear it during the process of breaking the glass of the window, and removal of glass from the window frame (as further discussed below). Accordingly, as an alternative to a mylar or Kevlar® layer, any other material having suitable characteristics can be used.

First layer 22 is provided with an adhesive 26 and a backing material 28 applied to the back surface thereof. Adhesive 26 is of a composition chosen to strongly adhere to glass; or alternatively, to adhere to those window materials contemporarily being used in the art at the time that the invention is to be utilized. In other words, the adhesive is selected to securely adhere layer 22 to glass (or such other window material), such that when layer 22 is adhered to the window and force is applied to the layer 22 to break the glass, the glass will nonetheless remain tightly held onto the adhesive. Thus, when the device is placed in contact with the window and force is applied, the adhesive will cause layer 22 to adhere to the window material before and after the window is broken. In one preferred embodiment, the adhesive used is Rohm Haas MORSTIK 607 acrylic polymer.

Backing 28 is a peel off layer of a material that can easily be removed from adhesive 26. Thus, window removal device 18 includes a first layer of material 22, a second layer of adhesive 26 and a third layer of backing material 28, with the adhesive being sandwiched between the first layer and the backing, as shown in FIG. 1. It should be noted that the dimensions of the embodiment of the figures are not to scale, with the thickness of the layers in FIG. 1, for example, being exaggerated merely for illustration purposes.

Window removal device 18 can be provided in any desired shape, whether circular, rectangular, or so forth. In the preferred embodiment, the material is shaped like a car window, as shown in FIG. 2. Further preferably, the material is shaped for affixation to a vehicle side door window to allow extractions from the side of the vehicle, or is shaped for affixation to the vehicle's rear window.

In a further preferred embodiment of the invention, sheet 22 includes a force application area 30 thereon. Force application area 30 can be an opening extending through one or more layers of the device, e.g. a hole punched all the way through. In an alternate embodiment, all of the layers of the device are intact, but with the first layer of the device (or a sublayer thereof) being provided with a reduced thickness in a given region.

This opening or thinned area is utilized to provide no or little cushioning to a blow directed to area 30, causing the force of the blow to be more fully transmitted to the window behind the device during use, as discussed below. Preferably, force application area is provided in a position away from where the occupant of the vehicle normally sits. For example, the area can be provided in the corner of the window close to the dashboard, in the case of a driver's side window.

If desired, multiple force application areas can be provided. In this embodiment, the most suitable area can be chosen at the time of use in view of the positioning of the occupant within the vehicle at that moment, e.g., whether slumped over the steering wheel or with his or her back against a seat, or so forth.

Alternatively or additionally to an opening or thinned area, one or more areas can be marked on the window for application of force thereto. Such area(s) can be designated with a bulleye, a circle, and/or appropriate text, or so forth. The marked area and/or force application area can be provided at any location or locations desired, whether in one or more corners of the device, in the center of the device, along an edge of the device, on the right side, left side, top or bottom of the device, or so forth.

In accordance with the method of the invention, device 18 is utilized for breakage and removal of a window from an existing structure. In the preferred embodiment, for example, device 18 is a rescue tool used at the scene of a vehicular accident. To use the device, the rescue worker (or other user) removes backing material 28 from the device, exposing adhesive 26 on the back surface.

Preferably, tabs 32 are attached to the backing material 28, so as to facilitate removal of the backing material. Two tabs 32, for example, are shown on the top side of the device 18, and extending off of the device, as shown in FIG. 2. In an alternate and preferred embodiment, the tabs 32 are attached to and/or extend off of, the two bottom corners. It will be understood, however, that as many tabs as desired can be utilized, that they can be of any size suitable for a user to comfortably grasp to remove the backing material 28, and that they can be placed on any one or more sides of the device 18.

Once the adhesive 26 is exposed, the back surface is then placed against and onto the window of the vehicle in the accident, to adhere the device 18 to the window to be removed. Upon adhesion of the sheet to the window, a strong blow is directed against the sheet of material, whether with a heavy object or a suitable tool (e.g. a spring loaded device used for breaking windows such as a center punch), or so forth. In the embodiment utilizing a force application area 30 as described above, this blow is directed at such area 30. The force of the blow is used to intentionally break the glass of the window that the sheet is adhered to. In the case of a vehicle, this window glass is often “safety glass” designed to shatter into small pieces upon impact.

Once the glass has been broken, device 18 is pulled backward to remove the broken glass adhered thereto out of the window frame. Due to the fact that the glass is adhered to the back of the device as discussed above, the glass of the window remains essentially in place when the window is broken, and does not shatter or spray upon the vehicle's occupants. The device is particularly effective when used with the safety glass commonly provided in vehicle side windows.

In a preferred embodiment, window removal device 18 can be further provided with handles 34 to facilitate the pulling back of the sheet and removal of the broken glass from the window frame. Handles 34 are preferably constructed of a suitable material having a light weight and flexibility, to allow folding up of the handles and the device when not in use.

The device, therefore, provides a means for rapidly removing the window of a vehicle or other structure, while minimizing injury from the shattering of glass onto the structure's occupants. The device is further lightweight, and compact, and able to be folded into a small package for storage on an emergency services vehicle. Preferably, the device is also disposable, i.e., the device can be wrapped up upon itself with the glass shards inside after the window is broken, to allow discarding of the device with safe removal and disposal of the glass contained therein.

Having described this invention with regard to specific embodiments, it is to be understood that the description is not meant as a limitation since further embodiments, modifications and variations may be apparent or may suggest themselves to those skilled in the art. It is intended that the present application cover all such embodiments, modifications and variations.

What is claimed is:

1. A method, comprising the steps of:
(a) taking a device comprising a material having an adhesive layer;
(b) positioning said adhesive layer against a window, to adhere said device to the window;
(c) applying a force against said device to break the window adhered to said device; and,
(d) pulling said device.

2. A method as claimed in claim 1, wherein said window comprises glass in a window frame, said adhesive layer is adhered to said glass, said force is applied to break the glass of the window, and said device is pulled to withdraw the glass from the window frame.

3. A method as claimed in claim 1, wherein said adhesive layer is positioned against a vehicle window.

4. A method as claimed in claim 1, wherein said method is performed by a rescue worker.

5. A method as claimed in claim 3, wherein said method is performed by a rescue worker after a vehicular accident.

6. A method as claimed in claim 1, wherein said window comprises glass in the window frame of a vehicle, said adhesive layer is adhered to said glass, said force is applied to break the glass of the window of the vehicle, and said device is pulled to withdraw the glass from the window frame of the vehicle, after the vehicle is in an accident.

7. A method as claimed in claim 1, wherein said device includes at least a portion which is transparent, for viewing through said device and through the window when said device is adhered to the window.

8. A method as claimed in claim 1, wherein said device further includes fibers for reinforcing said material against puncture by broken glass.

9. A method as claimed in claim 1, wherein said step of pulling said device comprises the step of pulling on least one handle of said device.

10. A method as claimed in claim 1, wherein said step of pulling said device comprises the step of pulling on two handles of said device.

11. A method as claimed in claim 1, wherein said device comprises an area marked for application of force to said device to break the window adhered to said device.

12. A method as claimed in claim 11, wherein said area further comprises a reduced thickness of said material of said device.

13. A method as claimed in claim 1, wherein said device is in the shape of a vehicle window.

14. A method as claimed in claim 1, wherein said device comprises a backing layer, said backing layer being provided for covering said adhesive before use of the device, and being removable to expose said adhesive for adhering said adhesive to the window.

15. A method as claimed in claim 14, further comprising the step of pulling a tab to remove said backing layer and expose said adhesive.

16. An apparatus, comprising:
a window removal device, said window removal device comprising a sheet of material sized for application to a vehicle window, said material being a material which resists puncture from broken glass;
said window removal device further comprising a layer of adhesive selected for securely adhering said material to glass;
said window removal device further comprising a layer of backing material, said layer of backing material being provided for covering said adhesive before use of the device and being removable to expose said adhesive.

17. An apparatus as claimed in claim 16, wherein said device is in the shape of an automobile window.

18. An apparatus as claimed in claim 16, wherein said device is in the shape of the side door window of an automobile.

19. An apparatus as claimed in claim 16, wherein said device includes at least a portion which is transparent, allowing viewing through said device.

20. An apparatus as claimed in claim 16, wherein said material is mylar.

21. An apparatus as claimed in claim 16, wherein said device further includes fibers for reinforcing said material.

22. An apparatus as claimed in claim 16, wherein said device comprises at least one handle.

23. An apparatus as claimed in claim 16, wherein said device comprises two handles.

24. An apparatus as claimed in claim 16, wherein said device comprises an area marked for application of force to said device.

25. An apparatus as claimed in claim 16, wherein said device comprises an area in which the thickness of said material of said device is reduced.

26. An apparatus as claimed in claim 16, wherein said device comprises a tab for use to assist in removal of said layer of backing material.
